(19) United States
(12) Patent Application Publication
(10) Pub. No.: US 2013/0235186 A1
(43) Pub. Date: Sep. 12, 2013

(54) Apparatus and Method for Inspecting Chip Defects

(71) Applicants: Ming-Fu Chen, Hsinchu (TW); Po-Hsuan Huang, Hsinchu (TW); Yung-Hsiang Chen, Hsinchu (TW)

(72) Inventors: Ming-Fu Chen, Hsinchu (TW); Po-Hsuan Huang, Hsinchu (TW); Yung-Hsiang Chen, Hsinchu (TW)

(73) Assignee: NATIONAL APPLIED RESEARCH LABORATORIES, Taipei (TW)

(21) Appl. No.: 13/416,010

(22) Filed: Mar. 9, 2012

(51) Int. Cl. H04N 7/18; G06K 9/00

(52) U.S. Cl. 348/126; 382/149; 348/E07.085

(57) ABSTRACT

Disclosed is a chip defect inspection apparatus including a linear array image acquisition module, an illumination control module, a chip defect detection module connected to the LIA module, and an operations and management module connected to the LIA module, the illumination control module and the chip defect detection module.

### TECHNICAL FIELD OF THE INVENTION

The present invention relates to an apparatus and method for inspecting chip defects; more particularly, relates to a chip inspection apparatus including a high-definition opto-mechanical image acquisition module with a linear array imager, and a chip defect inspection method including the chip image derivation and the chip defect inspection.

### DESCRIPTION OF THE RELATED ART

Conventionally, to inspect chip defects, a frame array imager is used to acquire images of a chip. For a long chip, several images are acquired with pauses between two adjacent shots. For example, the operation is lengthy because of the pauses. Image radiometric and geometric calibration, and mosaic are needed because several images are acquired for a chip. The difficulty of image acquisition control is increased. The moving parts and control elements for image acquisition are vulnerable to damage. Conclusively, the inspection of chip defects is ineffective. Hence, the inspection of chip defects is mostly manual, lengthy, expensive and less accurate.

Hence, the prior art does not fulfill all users' requests on actual use.

### SUMMARY OF THE INVENTION

The main purpose of the present invention is to satisfy the needs of a packaging workbench manufacturer by providing an chip defect inspection apparatus including a high-definition opto-mechanical image acquisition module with a linear array imager.

Another purpose of the present invention is to avoid the problems with the pauses in the operation of the conventional chip defect inspection apparatus by providing a chip defect inspection apparatus for acquiring a raw image of a chip while transporting the chip at constant speed during chip packing process.

Another purpose of the present invention is to provide a chip defect inspection apparatus for providing an image of each chip without the needs for image correction and mosaic.

Another purpose of the present invention is to provide a chip defect inspection method including the chip image derivation and the chip defect inspection based on binary edge image.

Another purpose of the present invention is to provide a chip defect inspection apparatus with advantages of efficiency, simplicity, durability, automation, inexpensiveness, and accuracy.

To achieve the foregoing objectives, the chip defect inspection apparatus includes a Linear array Image Acquisition (“LIA”) module, an illumination control module, a chip defect detection module connected to the LIA module, and an operations and management module connected to the LIA module, the illumination control module and the chip defect detection module. The LIA module includes an opto-mechanical image acquisition module and an image acquisition module for obtaining a raw image of a chip for defect inspection according to parameters of the opto-mechanical image acquisition module. The opto-mechanical image acquisition module includes an opto-mechanical module and a line scan imager. The illumination control module includes an illumination control mechanism and an illumination control circuit for regulating a light source to facilitate the LIA module to obtain a sufficiently distinct image of the chip according to illumination control parameters. The illumination control mechanism includes an image acquisition area mechanism, an LED illuminator and a radiator. The chip defect detection module includes an acquisition sequence control unit, an image acquisition and storage unit, an image processing unit and a defect inspection unit for instant raw image acquisition of the chip according to synchronization signal from machine control module, executing the instant processes of chip image derivation and defect inspection according to the image processing parameters and determination parameters, and then providing the result of inspection. The operations and management module includes a graphical user interface (GUI) for system operations and management, a system configuration unit, a system status handling unit, and an inspection result handling unit for registeration, display and statistics. The operations and management module registers and displays the state of the system including the LIA module, the illumination control module and the chip defect detection module. The operations and management module sets parameters for the state of the LIA module, the illumination control module and the chip defect detection module according to the chip size and system configuration. The operations and management module provides the opto-mechanical image acquisition parameters for the LIA module, the illumination control parameters for the illumination control module, and the processing parameters and the determination parameters for the chip defect detection module. The operations and management module receives the results of the inspection from the chip defect detection module, and registers, displays and executes statistics on the results of the inspection. The operations and management module registers the state of the system, the configuration of the system and the results of the inspection in an archive system.

In a specific aspect, the chip defect inspection apparatus includes an opto-mechanical image acquisition device and a computer supported on a workbench. The image acquisition module, the chip defect detection module and the operations and management module are included in the computer.

Another purpose of the present invention is to provide a chip defect inspection method based on edge detection and a binary chip edge image. The method is composed of 2 parts, including the chip image (region of interested) derivation and the chip defect inspection. The chip image derivation includes steps of the edge detection for chip edge designation, the boundary and corners derivation of chip, the parameters derivation of Affine Transformation, and image segmentation for chip image and chip edge image. The chip image is gray-level-based and the chip edge image is binary-based. Image resampling methods of Bilinear interpolation and Nearest Neighboring are applied to segment the chip image and the chip edge image respectively. Chip defect inspection is performed based on the binary chip edge image. Procedures of chip defect inspection includes the edge pixel statistic derivation, defect size derivation, and crack angle derivation.

Accordingly, a novel apparatus and a novel method for inspecting chip defects are obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a block diagram showing a chip defect inspection apparatus according to the first embodiment of the present invention;

FIG. 2 is another block diagram showing the chip defect inspection apparatus;

FIG. 3 is a perspective view showing an opto-mechanical image acquisition module of the chip defect inspection apparatus shown in FIG. 1;

FIG. 4 is a perspective view showing an illumination control mechanism at image acquisition area of the chip defect inspection apparatus;

FIG. 5 is a front view showing the opto-mechanical image acquisition module of the chip defect inspection apparatus shown in FIG. 2;

FIG. 6 is a side view showing the opto-mechanical image acquisition module of the chip defect inspection apparatus shown in FIG. 5;

FIG. 7 is a flowchart showing the defect inspection process of a chip defect inspection apparatus according to the second embodiment of the present invention;

FIG. 8 is a flowchart showing a processing subroutine for chip image derivation of a chip defect inspection apparatus according to the second embodiment of the present invention;

FIG. 9 is a flowchart showing a determining subroutine for defect inspection of a chip defect inspection apparatus according to the second embodiment of the present invention; and

FIG. 10 is a perspective view showing a sorter equipped with the chip defect inspection apparatus.

### DESCRIPTION OF THE PREFERRED EMBODIMENTS

The following descriptions of the preferred embodiments are provided to understand the features and the structures of the present invention.

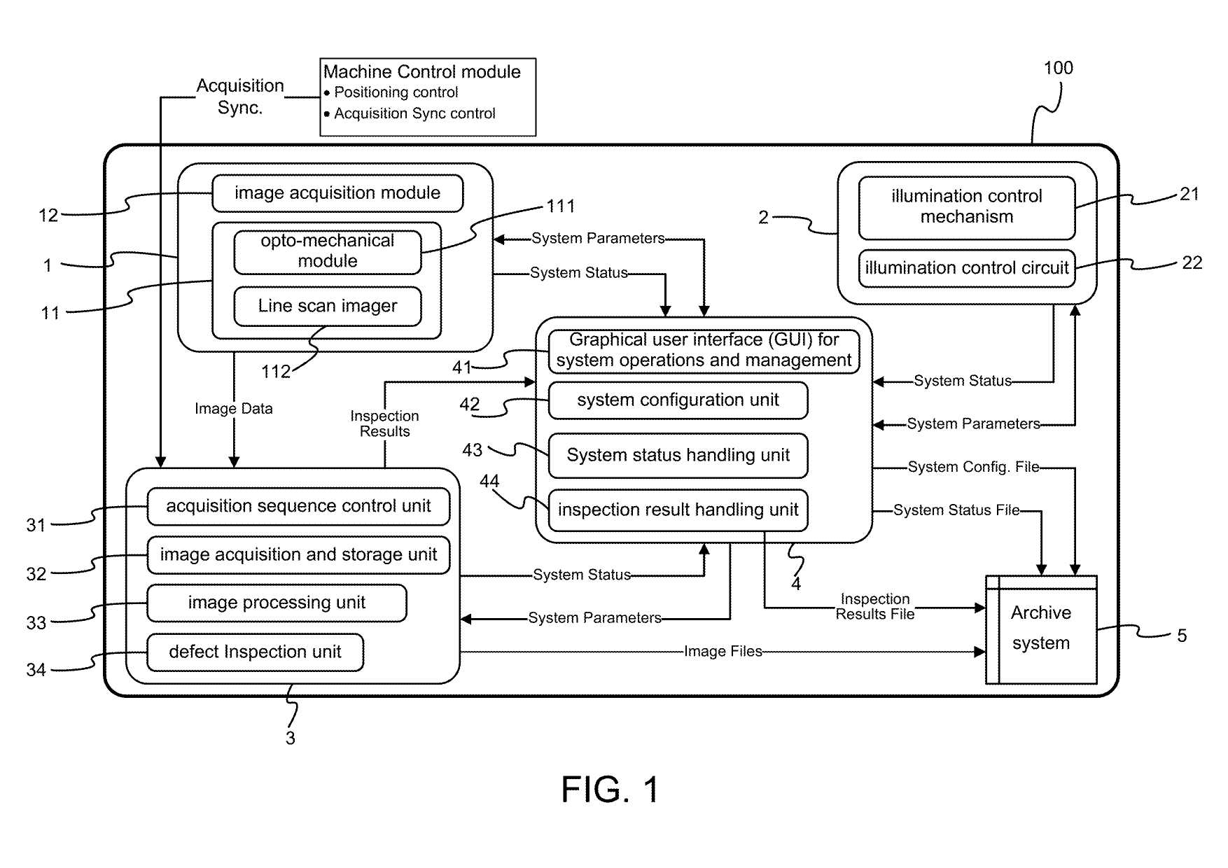

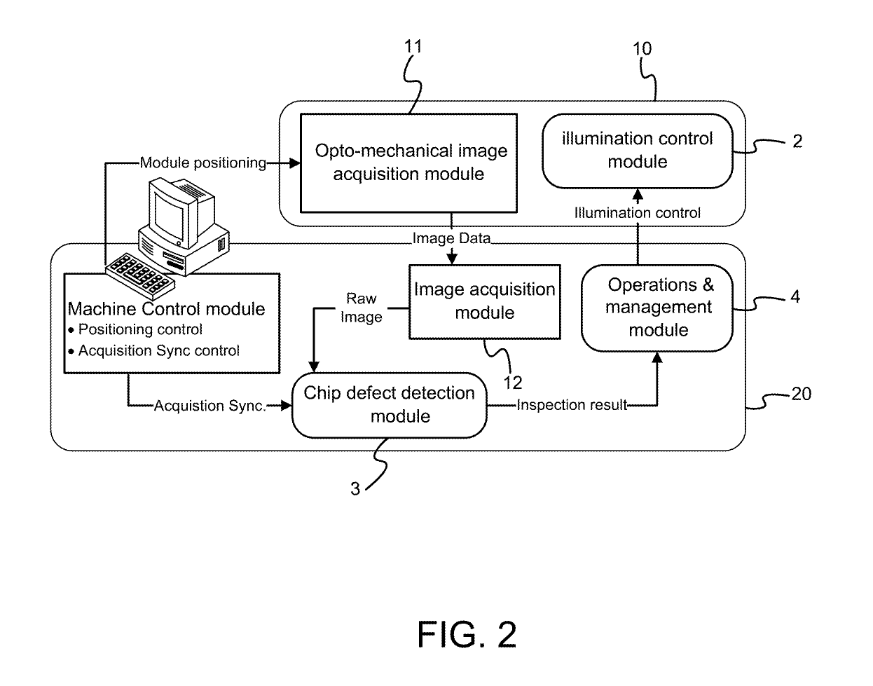

Referring to FIG. 1 and FIG. 2, there is shown a chip defect inspection apparatus 100 according to a first embodiment of the present invention. The chip inspection apparatus 100 includes a linear array image acquisition (LIA) module 1, an illumination control module 2, a chip defect detection module 3 and an operations and management module 4.

The LIA module 1 includes an opto-mechanical image acquisition module 11 and an image acquisition module 12. The LIA module 1 acquires raw image of a chip for inspection. The opto-mechanical image acquisition module 11 includes an opto-mechanical module 111 and a line scan imager 112.

The illumination control module 2 includes an illumination control mechanism 21 and an illumination control circuit 22 to regulate the light source to facilitate the LIA module 1 to obtain adequately bright images of the chip for inspection. LED illuminator is selected for the light source. And the band of light source can be red or near-infrared.

The chip defect detection module 3 is connected to the LIA module 1, and includes an acquisition sequence control unit 31, an image acquisition and storage unit 32, an image processing unit 33 and a defect inspection unit 34. The chip defect detection module 3 executes sequence control to obtain the raw image of the synchronization signal from a machine control module, and executes instant processes of raw image acquisition and defect inspection according to processing parameters and determination parameters, and provides a result of the inspection accordingly. The chip defect detection module 3 is a software module or a firmware module based on the hardware platform.

The operations and management module 4 is connected to the LIA module 1, the illumination control module 2 and the chip defect detection module 3. The operations and management module 4 includes a graphical user interface (“GUI”) for system operations and management 41, a system configuration unit 42, a system status handling unit 43 and an inspection result handling unit 44. The operations and management module 4 registers and displays the state of the system including the LIA module 1, the illumination control module 2 and the chip defect detection module 3. The operations and management module 4 registers and displays the state of the system including the LIA module 1, the illumination control module 2 and the chip defect detection module 3. Moreover, the operations and management module 4 sets parameters for the state of the LIA module 1, the illumination control module 2 and the chip defect detection module 3 according to the chip size and system configuration. In addition, the operations and management module 4 provides the opto-mechanical image acquisition parameters for the LIA module 1, the illumination control parameters for the illumination control module 2, and the processing parameters and the determination parameters for the chip defect detection module 3. Furthermore, the operations and management module 4 receives the results of the inspection from the chip defect detection module 3, and registers, shows and executes statistics on the results of the inspection. Finally, the operations and management module 4 registers the state of the system, the configuration of the system and the results of the inspection in an archive system 5. The operations and management module 4 is a software module.

The chip defect detection module 3 further registers the images in the archive system 5 after the inspection.

As shown in FIG. 2, the chip defect inspection apparatus includes the opto-mechanical image acquisition device 10 and a computer 20 provided on a packaging workbench. The image acquisition module 12, the chip defect detection module 3 and the operations and management module 4 are installed in the computer 20 provided on the workbench. When a chip is in need of inspection, the opto-mechanical image acquisition module 11 is positioned in an inspection area before the chip defect inspection apparatus is turned on and operations and management software is run to regulate the illumination control parameters and set system parameters according to the system configuration and the conditions of the chip under inspection. Then, the image acquisition module 12 begins to register the images into its scratch-pad memory from opto-mechanical image acquisition module 11.

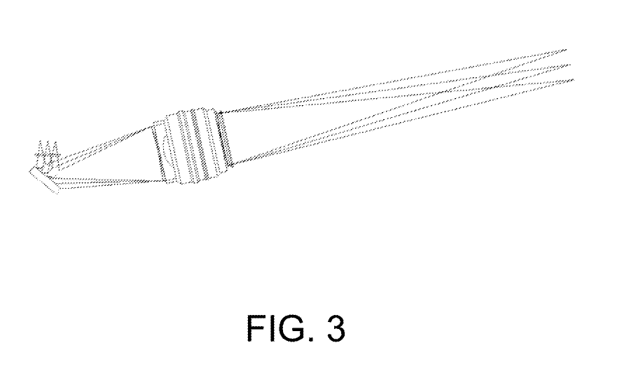

Referring to FIG. 3, the opto-mechanical image acquisition module is shown. There is shown the order of pixels for an image corresponding to the arrangement of the sensor of the opto-mechanical image acquisition module 11.

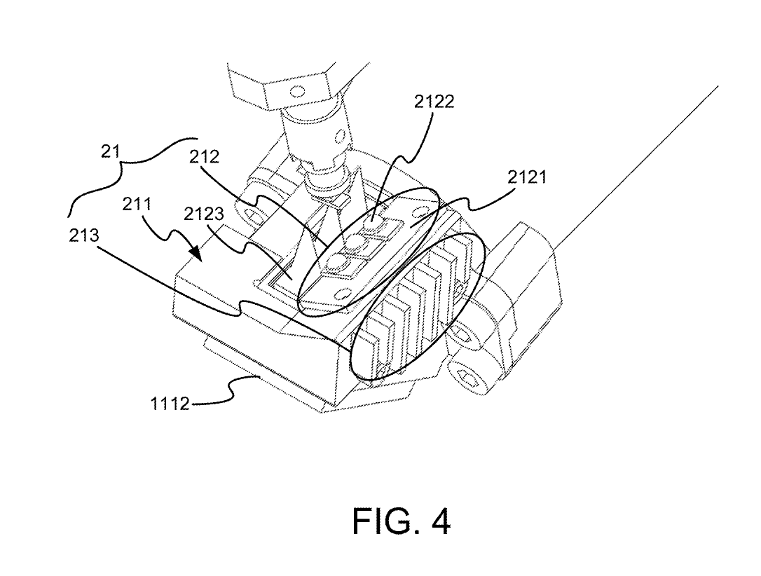

Referring to FIG. 4 through 6, the illumination control mechanism 21 includes an image acquisition area mechanism 211, an LED illuminator 212 and a radiator 213. As shown in FIG. 4, at least the radiator 213 is made of aluminum for removing heat from the LED illuminator 212 that consumes a lot of power in operation. The LED illuminator 212 includes an LED circuit board 2121, an LED illumination module 2122 and a filter 2123. The LED circuit board 2121 is a printed circuit board (“PCB”) sandwiched between two layers of copper for efficient radiation of heat and transfer of heat to the radiator 213.

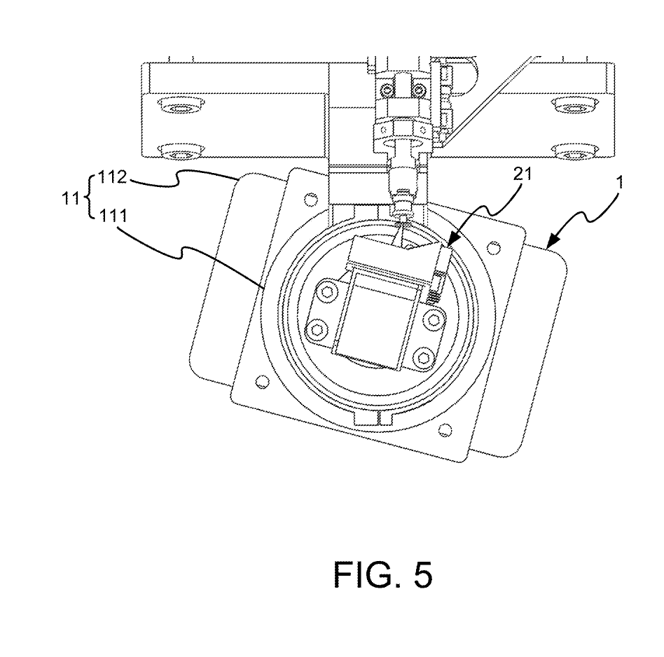

Referring to FIG. 5, the LIA module 1 is rotated for an angle and placed in an image acquisition position on the workbench. Thus, most light reflected from the chip enters a slit of the filter 2123 to get sufficient brightness for image acquisition.

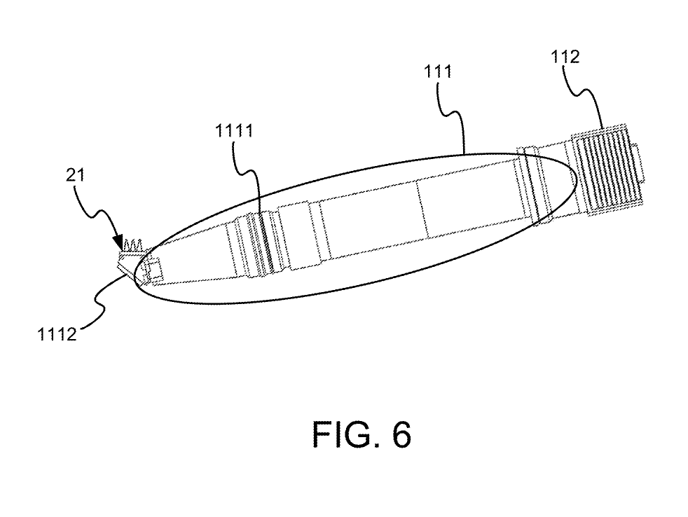

Referring to FIG. 6, the opto-mechanical image acquisition module 11 includes the opto-mechanical module 111 and the line scan imager 112. The opto-mechanical module 111 includes a lens 1111, a reflector 1112 and a filter (not shown).

Referring to FIG. 10, shown is a sorter equipped with the chip defect inspection apparatus 100. The LIA module 1 is supported on a workbench 7 of the sorter by a holding mechanism 6. Thus, the image acquisition area is placed on the path for transporting the chip below the PP head. The chip is transported at constant speed while it is imaged. The image is sent to the image acquisition module and then image processing and defect inspection are executed. The holding mechanism 6 includes a connecting mechanism 61 and a socket 62.

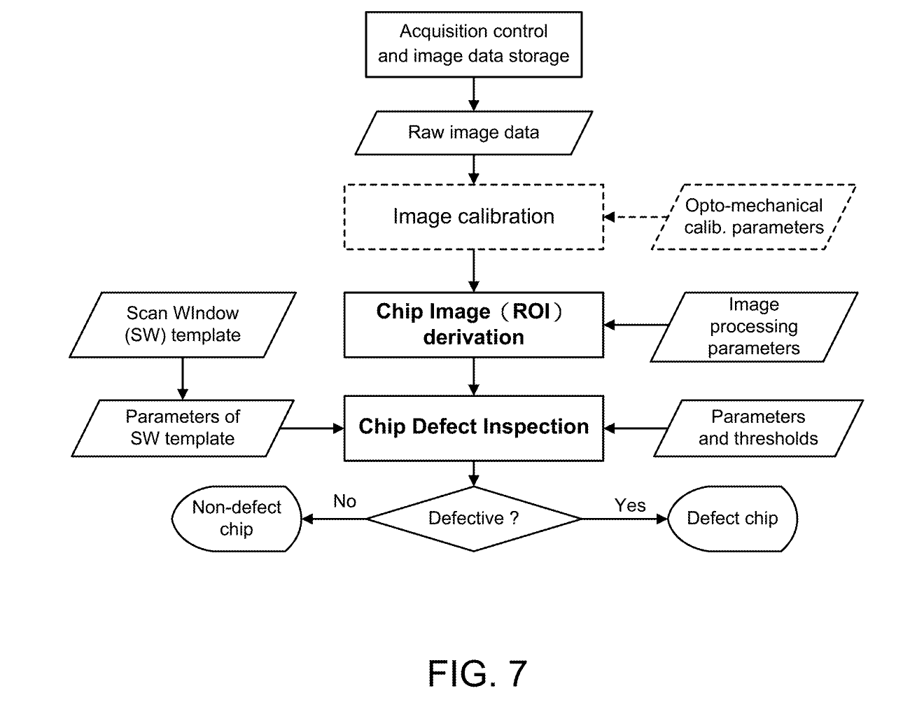

Referring to FIGS. 7, 8 and 9, shown is a chip defect inspection method according to a second embodiment of the present invention. In the chip defect inspection method, edge detection and binary chip edge image are used for inspecting the chip to increase the accuracy and efficiency. Referring to FIG. 7, after receiving the raw image from the LIA module 1, the process of image processing and chip defect inspection is performed. The procedure of image calibration is neglected based on using the lens and imager with very low variation of the relative illumination and the geometry distortion of less than 3% and 0.2% respectively within its coverage of image height. Therefore, the chip defect inspection method includes the processes of the chip image derivation and the chip defect inspection.

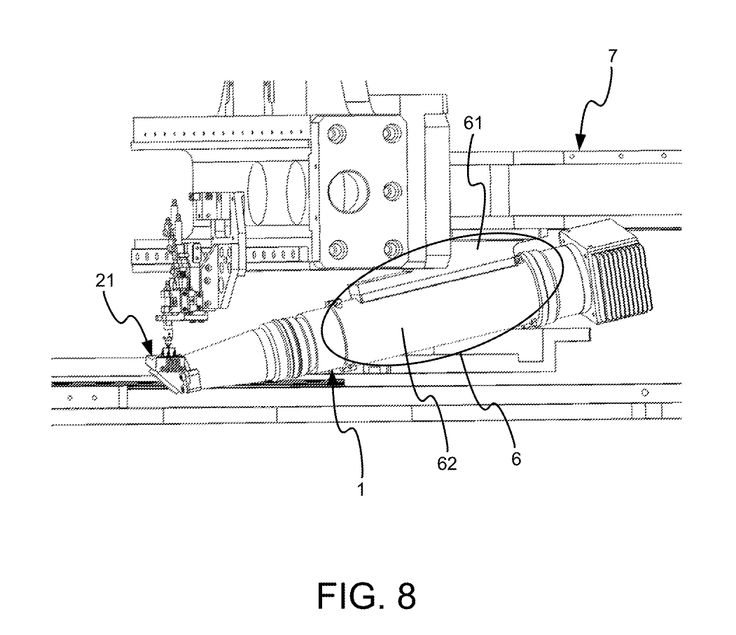

Referring to FIG. 8, the chip image derivation includes steps of the edge detection for chip edge designation, the boundary and corners derivation of chip, the parameters derivation of Affine Transformation, and image segmentation for chip image and chip edge image.

Referring to FIG. 9, chip defect inspection is performed based on the binary chip edge image to detect any cracks, chipping and residual glue on chip. Procedures of chip defect inspection includes the edge pixel statistic derivation, defect size derivation, and crack angle derivation. Defect size is calculated by using the pixel statistic distribution of edge image and edge template of defect in a scan window.

As discussed above, the chip defect inspection apparatus of the present invention exhibits several advantages. At first, the image of the chip for inspection is acquired during the transportation of the chip at constant speed, thus avoiding the problems with the pauses addressed in the Related Prior Art. Secondly, an image is acquired for each chip, thus saving the troubles of image correction and mosaic and reducing time for the image processing. Thirdly, the chip edge image is used to increase the accuracy and efficiency of chip defect inspection.

Therefore, the chip defect inspection system has characterictics of high inspection efficiency, simple structure for image acquisition, image acquisition without pauses, high inspection accuracy, and performing defect inspection automatically during packing process to reduce the labor and cost of manufacturing.

The preferred embodiment(s) herein disclosed is (are) not intended to unnecessarily limit the scope of the invention. Therefore, simple modifications or variations belonging to the equivalent of the scope of the claims and the instructions disclosed herein for a patent are all within the scope of the present invention.

1. A chip defect inspection apparatus including an opto-mechanical image acquisition device and a computer supported on a workbench, wherein the chip defect inspection apparatus includes:
a linear array image acquisition module including an opto-mechanical image acquisition module and an image acquisition module for obtaining a raw image of a chip under inspection, wherein the opto-mechanical image acquisition module includes an opto-mechanical module and a line scan imager;
an illumination control module including an illumination control mechanism and an illumination control circuit for regulating a light source to facilitate the linear array image acquisition module to obtain an adequately bright image of the chip, wherein the illumination control mechanism includes an image acquisition area mechanism, an LED illuminator and a radiator;
a chip defect detection module connected to the linear array image acquisition module, wherein the chip defect detection module includes an acquisition sequence control unit, an image acquisition and storage unit, an image processing unit and a defect inspection unit to obtain the raw image of the chip according to synchronization signal from the machine control module, execute defect inspection process according to image processing parameters and determination parameters, and provide the results of inspection; and
an operations and management module connected to the linear array image acquisition module, the illumination control module and the chip defect detection module, wherein the operations and management module includes a graphical user interface for system operations and management, a system configuration unit, a system status handling unit, and an inspection result handling unit for registeration, display and statistics, wherein the operations and management module registers the state of the system, the configuration of the system and the results of the inspection in an archive system, wherein the image acquisition module, the chip defect detection module and the operations and management module are included in the computer.

2. The apparatus according to claim 1,
wherein the chip defect detection module is a software or firmware module based on hardware platform.

3. The apparatus according to claim 1,
wherein the operations and management module is a software module.

4. The apparatus according to claim 1,
wherein the opto-mechanical module includes a lens, a reflector, a filter and adapters.

5. The apparatus according to claim 1,
wherein the light source is selected from the light group consisting of red and near-infrared bands.

6. The apparatus according to claim 1,
wherein the LED illuminator includes a printed circuit board, an LED illumination module and a filter.

7. The apparatus according to claim 1,
wherein the chip defect detection module registers the images in the archive system after the inspection.

8. The apparatus according to claim 1,
wherein the determination parameters include parameters and thresholds for detecting and determining, and parameters of scan window template.

9. The apparatus according to claim 1,
wherein the linear array image acqusition module is supported on the workbench via a holding mechanism.

10. A chip defect inspection method based on edge detection and a binary chip edge image including the instant chip image derivation process and chip defect inspection process.

11-13. (canceled)

14. The apparatus according to claim 1,
wherein the chip defect detection module includes an acquisition sequence control unit, an image acquisition and storage unit, an image processing unit and a defect inspection unit.
